(19) United States
(12) Patent Application Publication
(10) Pub. No.: US 2007/0112766 A1
(43) Pub. Date: May 17, 2007

(54) Method for facilitating interaction

(76) Inventors: Elbert Hu, Rockville, MD (US); Hubert Hu, Redmond, WA (US)

Correspondence Address: ANDREW MCALEAVEY, 4600 ADELINE ST., #101, EMERYVILLE, CA, 94608, US

(21) Appl. No.: 11/270,873

(22) Filed: Nov. 8, 2005

(51) Int. Cl. G06F 17/30

(52) U.S. Cl. 707/6

(57) ABSTRACT

A method of facilitating interaction is disclosed. The method comprises gathering substantially anonymous, match-relevant information from a first entity to form a first profile, matching the first profile with another profile belonging to a second entity, and causing or encouraging the first and second entities whose profiles match to go to a particular venue or event at a predefined time. A matching service and methods of selective marketing to entities participating in the methods and service are also disclosed.

### BACKGROUND OF THE INVENTION

1. Field of the Invention

The invention relates to methods for facilitating interaction.

2. Description of Related Art

As the number of regular Internet users has increased, social interaction and networking, particularly on the World Wide Web, have become increasingly popular online activities. World Wide Web-based social interaction and networking may take many forms, ranging from business-to-business websites and business networking websites to interactive websites and services with more personal objectives.

One type of service that has had resurgence online is the dating or matchmaking service. Matchmaking is an age old art, and a dating service or matchmaking service typically seeks to find individuals whose personalities are compatible and match them, be it for friendship, marriage, or some other type of relationship. Several permutations of the online matchmaking service exist. In one permutation, each individual fills out a profile with basic information, such as age, gender, and interests. The profiles are stored and indexed, and on command, the service provides a list of users that matches user-selected criteria. The user who requests the list can then browse for possible matches among the list. In another permutation, a user fills out a profile with basic information, is asked a certain number of questions that require some thought or introspection, and is then automatically presented with a list of presumptive matches. Matching algorithms are used to match the requesting user's profile automatically with the prospective matches.

Despite their popularity, online matchmaking services sometimes carry a certain stigma for their users. Some users are loath to submit to the matchmaking judgment of a machine; other users may be disheartened or embarrassed by their decision to join the matchmaking service. Even with matchmaking services whose purpose is strictly business-related, some users may doubt the efficacy of online versus in-person interaction. These factors can reduce the efficacy of the matchmaking services and cause otherwise good matches to fail.

### SUMMARY OF THE INVENTION

One aspect of the invention relates to a method of facilitating interaction. The method comprises gathering substantially anonymous, match-relevant information from a first entity to form a first profile, matching the first profile with another profile belonging to a second entity, and causing or encouraging the first and second entities whose profiles match to go to a particular venue or event at a predetermined time.

Another aspect of the invention relates to a method of selective marketing. The method comprises obtaining venue or event preferences related to an event, gathering substantially anonymous match-relevant information from a first entity to form a first profile, and matching the first profile with another profile belonging to a second entity. The method further comprises causing or encouraging first and second entities whose profiles match each other and the venue or event preferences to go to the venue or event.

Yet another aspect of the invention relates to a matching service. The matching service administers questionnaires indicative of geographical location and personality to a plurality of individuals using an interactive interface, matches ones of the plurality of individuals based on the questionnaires, and causes or encourages matched ones of the plurality of individuals to go to a particular venue or event at a predetermined time.

These and other aspects, features, and advantages of the invention will be set forth in more detail in the description that follows.

### BRIEF DESCRIPTION OF THE DRAWINGS

The invention will be described with respect to the following drawing figures, in which like numerals represent like elements throughout the figures, and in which:

FIG. 1 is a schematic flow diagram of a method of facilitating interaction according to one embodiment of the invention;

FIG. 2 is a schematic diagram of a system capable of executing the method of FIG. 1;

FIG. 3 is an illustration of a sample questionnaire that may be administered in the method of FIG. 1;

FIG. 4 is an illustration of an exemplary e-mail communication that may be used in the method of FIG. 1;

FIG. 5 is an illustration of another exemplary e-mail communication that may be used in the method of FIG. 1;

FIG. 6 is an illustration of yet another exemplary e-mail communication that may be used in the method of FIG. 1; and

FIG. 7 is a schematic flow diagram of a method of facilitating interaction according to another embodiment of the invention.

### DETAILED DESCRIPTION

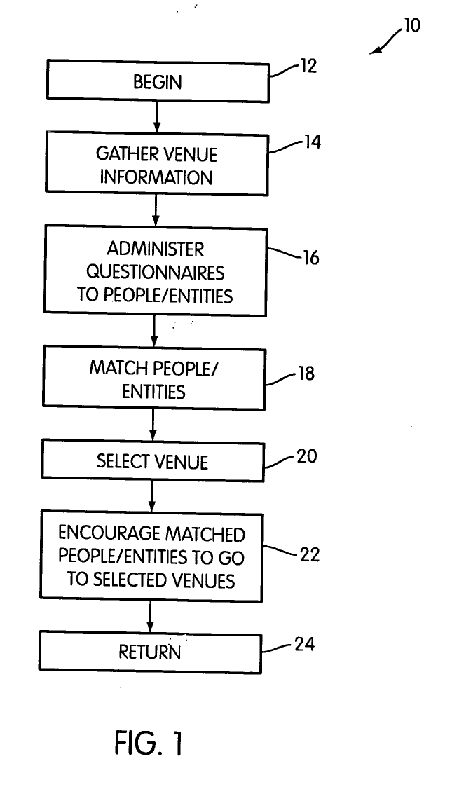

FIG. 1 is a schematic flow diagram of a method of facilitating interaction, generally indicated at 10, according to one embodiment of the invention. Certain aspects of method 10 will be described with respect to the particular application of matching people for dating or romantic relationships, although other methods according to embodiments of the invention may be applied in other contexts. Moreover, although method 10 may be performed in any manner, certain tasks of method 10 benefit from the use of computing devices and a network, as will be explained below.

Method 10 begins at task 12, and continues with task 14. In task 14, information related to at least one venue is obtained. As the term is used here, “venue” refers to a specific physical location in which two or more people may congregate, although in most embodiments, it is desirable if the venue allows people to socialize relatively freely as well. Examples of venues include bars, clubs, lounges, and restaurants. In a broader sense, the term “venue” should also be construed to cover events, including concerts, charity events, and the like. Venue information may be obtained manually by personal contact with a venue owner or proprietor, it may be obtained by the promulgation of a questionnaire through an interactive interface, such as a questionnaire administered via the World Wide Web, or it may be obtained in some other way. Once information on venues is obtained, it is typically stored in a database or other suitable indexable storage mechanism.

The different types of venue information that are gathered may vary from embodiment to embodiment. In general, venue information may include the size of the venue and average number of patrons per day and per time period within that day, the style of the venue (bar, club, lounge, etc.), the type of music or entertainment, the type of food, and any other proprietary categories or other information that would tend to establish the ambience or other characteristics of the venue. If the venue involves an event, venue information may include the time and date of the event, the expected total number of event-goers, and the nature of the event itself. The uses to which this information may be put will be described in greater detail below.

The number of venues for which information is gathered may vary from embodiment to embodiment. In general, information would be gathered on at least one venue in each geographical area in which method 10 is to be carried out, although it is advantageous to gather venue information on a plurality of venues in each geographical area in which method 10 is to be carried out.

Once the venue information is gathered and appropriately stored and indexed in task 14, method 10 continues with task 16, in which questionnaires seeking match-relevant information are administered to interested entities.

The term “entities” is a general one, and as such, refers to both individual people and business entities. In one embodiment, the entities to which the questionnaires are administered are individual people. In another embodiment, the entities are legal entities, such as businesses or corporations. In yet another embodiment, one of the entities may be a person and the other entity may be a business, legal entity, or representative of a legal entity. For example, one entity may be an individual and the other may be an event planner working on behalf of a particular event. Overall, method 10 may serve any two entities that wish to be matched for some purpose. In most embodiments, the questionnaires will be administered using an interactive interface on an electronic network.

For the sake of simplicity, the following description will assume that the two entities in question are individuals who wish to be matched. If the entity is an individual, the questionnaire administered in task 16 may include any questions seeking match-relevant information, that is, any questions seeking to elicit information on the individual's own personality or his or her preferences for a match. Representative examples of the types of questions that may be asked include questions indicative of the individual's race, gender, age, religion, gender for matching (man seeking woman, woman seeking man, man seeking man, woman seeking woman, etc.), personality, interests, and geographical location.

Many questions used to elicit information about an individual may also be asked again with respect to the desired characteristics of a potential match for that individual. When a question relates to the desired characteristics of a potential match, the individual may be asked how important that characteristic is in a potential match. For example, if an individual provides that they are looking for someone of a particular religion, they may also be asked to specify how important that characteristic is in a match.

Questions may also be asked to confirm that the individual is a real person, rather than a machine. For example, the individual may be asked to pass a CAPTCHA™ test, an automated test used to differentiate between humans and computers and to ensure that a human is providing the input requested. In a typical CAPTCHA™ test, a user is asked to read and type in a letter, word, or phrase that is displayed on the user's screen using characters that are not machine-readable.

Questions relating to personality may be asked in a straightforward manner (e.g., “Are you a social person?”) or they may be asked more obliquely (e.g., “Would you prefer to go to a party or read a book?”). Rather than asking about a certain personality characteristic itself, questions may focus on certain traits indicative of personality characteristics. Questions may also be asked several times in a variety of subtly different ways in order to determine whether the individual is consistent in his or her answers. In addition, questions may be presented in the form of scenarios, with the various answer choices being indicative of certain personality traits. For example:
If your boyfriend/girlfriend had a job interview but was not given the job and subsequently came to you upset, would you:
A. Try to define why they were not given the job and improve their skills?
B. Offer general comfort?
C. Try to take their mind off the topic and not discuss it?

In general, the art of assessing an individual's personality and other psychological characteristics, including personality type, conflict and conflict resolution styles, and interests is an old one, and any questions or questioning methods common in those arts may be used in method 10. However, although it may be desirable in some embodiments to have a relatively complete view of an individual's personality, it may not be necessary in all embodiments. The questionnaire gathers match-relevant information and, for example, if the match is for business purposes, match-relevant information may include only business-related preferences and attributes.

For purposes of informing the individual of potential matches, the questionnaire may also solicit basic contact information, such as e-mail address, instant message address, or some other form of contact information. However, it is advantageous if the questionnaire solicits only the minimum basic information necessary to contact the individual. For example, a questionnaire might solicit an e-mail address or an instant messenger screen name, but not a home address or home telephone number. In other words, the questionnaire generally solicits personal information (i.e., related to personality and personal preferences) but not identifying information. For these reasons, the information gathered during task 16 may be described as “substantially anonymous.”

Although an e-mail address is identifying to some extent, e-mail addresses may be set up with relatively little difficulty and generally without supplying a significant amount of personal information. The user does not have to use an e-mail address associated with his or her name, workplace or home. In some embodiments, users may be given the choice of establishing a “blinded” or anonymous e-mail address specifically for use with method 10. Depending on the embodiment, the operator of method 10 may create and dispense “blinded” or anonymous e-mail addresses or the user may be directed to a third party commercial provider of e-mail accounts, such as Google (Gmail), Yahoo! (Yahoo! Mail), or Microsoft (Hotmail).

In seeking personal information but not specifically identifying information, method 10 seeks to reduce the burden on the individual and reduce or eliminate any trepidation that might be occasioned by supplying identifying information, hopefully making it more likely that the individual will participate. Generally speaking, an advantage of method 10 is that the burden on the individual in participating in the method is reduced as much as possible.

Typically, questionnaires would be administered to a plurality of individuals. Once administered, the results of a questionnaire would be stored in an appropriate database and may be processed or mined to identify particular characteristics. The results of the questionnaires may be stored in a database explicitly in the form of the answers given to the questionnaire, or the results may be stored in a processed form indicative of preferences and personality traits. The data collected by the questionnaire, whether further processed or not, represents a profile of the entity (in this example, the individual) who answered the questions.

Although the questionnaire represents the primary vehicle for obtaining a profile of an entity, there is no requirement that an entity be given a questionnaire in order to establish a profile. For example, data already in a processed form could be directly entered and stored in order to establish a profile. A profile may also be established using a combination of data already in a processed form and data from a questionnaire or other source.

Periodically, once questionnaires are administered in task 16 of method 10 and profiles are established, method 10 continues with task 18, in which entities are matched based on their profiles. The objective of task 16, the matching task, is to find entities whose profiles match. Whether or not two profiles match is determined by a set or rules or an algorithm appropriate for the particular embodiment. The particular matching algorithm that is used is not critical to the overall conduct of method 10. Additionally, it is not necessary that the matching algorithm use every piece of information collected in a particular profile.

In the simplest embodiment, matching two profiles may comprise matching specific qualities or characteristics in those profiles. For example, if a male, age 25, specifies that he is looking for a female, ages 25-35, task 18 may comprise selecting all females of ages 25-35 that are in the database as matches for the male profile.

In the above example, the matching algorithm considered only the preferences expressed in one profile to create the matches. More sophisticated matching algorithms may be used which take into account the preferences or characteristics of both or all profiles in making a match. For example, to modify the example above, a match might only be declared if the male's profile also falls within the preferences specified by the female profile (i.e., each of the female profiles would also have to specify that they were seeking 25 year old males). More generally, a number of matching and conjoint analysis algorithms are known in the art, and any of those algorithms may be used in embodiments of the invention. For example, the matching and closeness-of-fit decision-making algorithms disclosed in U.S. Pat. Nos. 5,963,951, 6,272,467, 6,735,568, 6,826,541, and 6,915,269 and U.S. Patent Application Publication No. 2005/0164152A1, the contents of all of which are hereby incorporated by reference in their entireties, may be used in embodiments of method 10.

Regardless of the particular matching algorithm that is used, it is generally advantageous for each profile to match at least one other. The reasons for this will be explained below in greater detail. Therefore, whatever criteria are used to specify or obtain a match, it may also be helpful to define. a match using sliding criteria. For example, if a particular profile does not match any other profile, that profile may be re-matched using a match threshold of an 80% match. As this illustrates, it is not necessary for matched profiles to have 100% identity in their preferences, interests, or other match-relevant information.

The overall objective of task 18 is to produce a list of at least two, but often more than two, individuals who are thought to be matches. Depending on the embodiment, task 18 may produce a list containing any number of individuals who are thought to be matches. For example, task 18 may produce a list of twenty individuals who are 80% matches, ten individuals who are 90% matches, etc.

Once entities are matched, method 10 continues with task 20, in which a venue is selected that is appropriate for the matched entities to meet. The venue may be selected using another matching algorithm, typically on the basis of the geographical location of the venue and the geographical location of the matched entities. It is generally advantageous to select a venue as close as possible to the geographical locations of the entities, so as to reduce the burden on the entities. Additionally, any venue information gathered in task 14 may be taken into account in matching a venue to entities, and any information gathered during task 16 may also be taken into account. For example, if twenty individuals who enjoy dancing are matched in task 18, it is advantageous if the venue selected in task 20 can hold twenty individuals and has an appropriately sized dance floor.

Method 10 then continues with task 22, in which the matched entities are caused or encouraged to go to the selected venue at a predetermined time. For example, twenty individuals who are considered to be at least 80% matches based on their profiles may be caused or encouraged to go to the selected venue at the same predetermined time. The overall effect of this is to create a situation in which each of those twenty individuals has a good chance of meeting a match at the venue. However, unlike most traditional matchmaking systems, method 10 does not require that the matched individuals arriving at the selected venue identify themselves as participants in method 10. The individuals are merely caused or encouraged to go to the venue and, in the embodiment that has been described, are not given any information on the other individuals who will be there. This provides a level of anonymity that removes the stigma of participating in a matchmaking service. Participants in method 10 are indistinguishable from the normal patrons of the venue; however, the total patronage of the venue at that particular predetermined time has been arranged so as to favor matching for each of the invited individuals.

Usually, upon filling out a questionnaire and providing match-relevant information in task 16, individuals are told that their responses will be used to determine matches, and are also told that they should expect further contact detailing where they can go to meet matches. With that understanding, the causing or encouraging of task 22 may be performed using e-mail messages, instant messages, or some other form of communication based on the contact information gathered in task 16.

Typically, questionnaires are administered and profiles are created on a continuous or nearly continuous basis. However, tasks 18, 20, and 22 of method 10 may be performed at specific intervals, rather than continuously. For example, task 18 may be performed only once or twice a week. For example, matching may be performed on Sunday, with e-mails sent Sunday night. Additional e-mails with additional venues and times may be sent out mid-week, for example, on Wednesday night. Depending on the embodiment, the information provided in the e-mails could be incomplete, such that it would require an individual to access another resource, such as a World Wide Web site, in order to ascertain the complete details.

Once the entities have been caused or encouraged to go to a particular venue at a predetermined time, method 10 terminates at task 24. However, method 10 may be repeated any number of times using the same profiles for the same individuals. Specific individuals or entities may cease participation by notifying the arranger of method 10.

In some embodiments, money may be collected for the performance of method 10. For example, each venue or event for which information is gathered in task 14 could be asked to pay an appropriate fee, such as a venue or event membership fee, for participating in the method. Other methods for collecting fees in connection with method 10 and other methods according to embodiments of the invention will be described in more detail below.

As was described above, method 10 may be most advantageously performed using a machine or system of machines interconnected by an electronic network, and the tasks described above with respect to method 10 may be encapsulated in a set of machine-readable instructions that are interoperable with a machine or system of machines to perform the tasks. For example, the tasks of method 10, and of the other methods described herein, could be encapsulated in computer software.

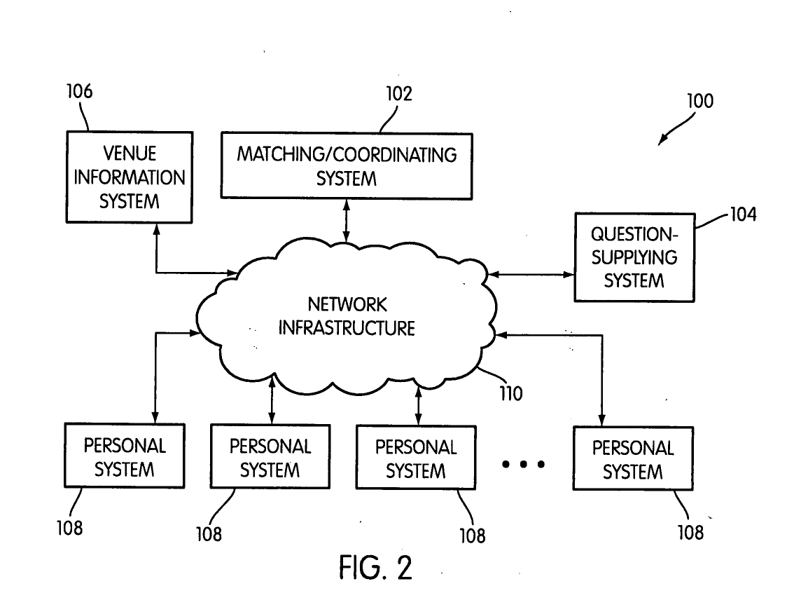

FIG. 2 is a schematic diagram of a system, generally indicated at 100, capable of performing method 10 of FIG. 1. The system 100 comprises a matching/coordinating system 102, a question-supplying system 104, a venue information system 106, and a plurality of personal systems 108 interconnected by network infrastructure 110.

In the description that follows, it is assumed that the network infrastructure 110 is that of a packet-switched network. Specifically, it is assumed that the network infrastructure 110 is the Internet. Moreover, in one embodiment, communications between the various systems 102, 104, 106, 108 of system 100 may be handled, at least in part, by hypertext transfer protocol (HTTP) over TCP/IP. However, other networks and networking protocols may be used.

Typically, the matching/coordinating system 102 would be responsible for performing the functions described above with respect to method 10, although those functions may be divided up and performed by any number of individual systems. Generally, the matching/coordinating system 102 would be a computer, but that term should be construed broadly to encompass all machines capable of performing the functions that are ascribed to the matching/coordinating system 102.

Most commonly, the matching/coordinating system 102, or a server connected to it, would maintain a World Wide Web site that, in cooperation with a client browser application on one of the personal systems 108, provides an interactive interface through which a questionnaire can be administered and answered. Although not shown in FIG. 2, additional database systems may be connected directly to the matching/coordinating system 102, or to the matching/coordinating system 102 through the network infrastructure 110 to provide storage for the individual profiles that result from the questionnaires. Profiles may be stored in any sort of database that allows them to be processed. For example, a structured query language (SQL) database may be used to store the profiles. Applications for matchmaking may also be programmed in an appropriate programming language, such as C, C++, or Java. The interactive web site may be written in HTML, XML, or any other capable language, supplemented as needed by an appropriate scripting language, such as JavaScript, Perl, or PHP.

The particular questions that comprise the questionnaire need not be compiled or stored on the matching/coordinating system 102, and in system 100, a question-supplying system 104 is also connected to the matching/coordinating system 102 through the network infrastructure 110. This arrangement allows the questionnaire development and storage to be “outsourced” and handled separately from the functions related to the administration of method 10. For example, in system 100, the questions may be developed and questionnaires may actually be administered by an outside vendor. For example, the interactive interface provided by the matching/coordinating system 102 may link the user, overtly or transparently, to the question-supplying system 104.

In a typical use of method 100, a user's personal system 108 would connect through the network infrastructure 110 to the matching/coordinating system 102 and would thus be able to access a web-based questionnaire. The personal system 108 used by an individual may be any sort of system, including desktop computers, notebook or laptop computers, personal digital assistants, cellular telephones, and Internet connectivity devices, such as Blackberries.

FIG. 2 also illustrates a venue information system 106 that is used to store the venue information gathered in task 14 of method 10.

The actual questionnaire that is administered in task 16 of method 10 may vary considerably in form from one embodiment to another. The particular form of the questionnaire will depend on the type and number of questions that are included on it. Although there is no particular limit on the number and type of questions that may be asked, it is generally advantageous to keep the number of questions to the minimum number that will establish the match-relevant information without overwhelming and creating a burden on the individual seeking to fill it out. In some embodiments, fifty questions may be a practical upper limit. Generally, the types of questions asked will be those that are most easily processed by a machine; specifically, the questionnaires may have multiple-choice and numerical fill-in answers, as opposed to free form linguistic answers. However, in some embodiments, answers may be more free-form in nature, particularly if the machines involved are equipped for word matching or natural language processing.

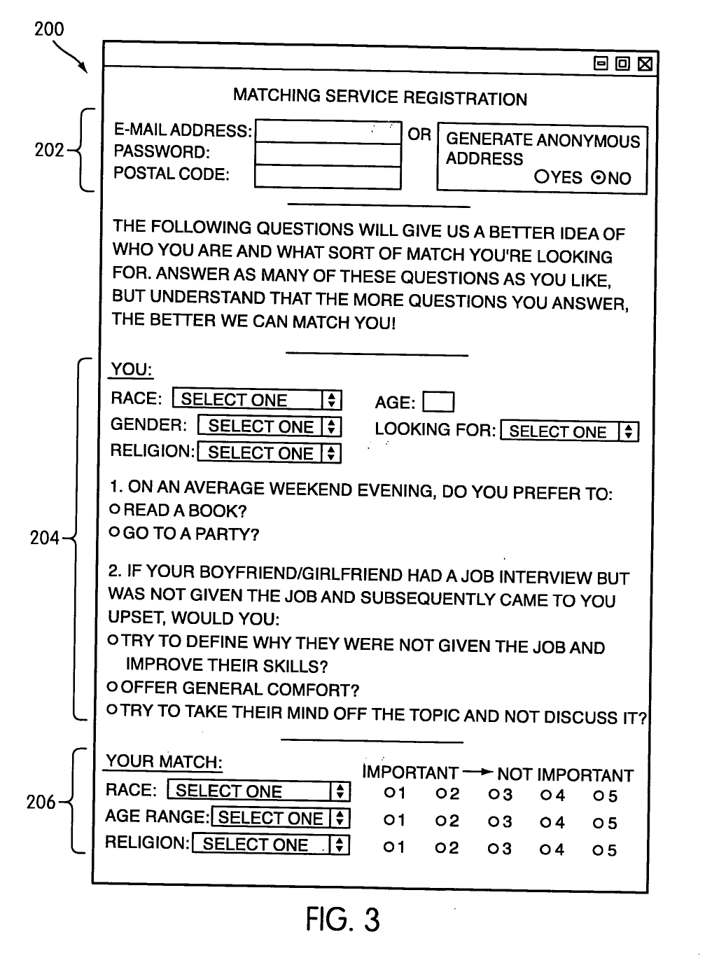

FIG. 3 is an illustration of a simple matching questionnaire, generally indicated at 200, which may be administered in method 10 and other methods of the invention. The questionnaire 200 would generally be viewed as a page inside a World Wide Web client browser application, such as Internet Explorer, Netscape, Safari, Opera or FireFox, and some elements of the interactive interface of the questionnaire would be determined in part by the interface features of the client browser application, subject to the instructions provided in the code of the questionnaire itself.

The questionnaire 200 is divided into three general areas: an individual contact information area 202, an individual information area 204, and a match information area 206. The individual contact information area 202 solicits the basic contact information necessary to contact the user in task 22 of method 10, which, in this case, includes an e-mail address, a geographical location specified by a postal code, and a password. The individual is also given the option to create an anonymous e-mail address specifically for use with the method, as was described above.

Of the information solicited in the individual contact information area 202, the password allows the individual to access his or her profile again if necessary, to correct or change information, to re-take all or part of the questionnaire, or to indicate new or different interests. As one particular example, if the user relocates, he or she could access his or her profile again to change the listed geographical location. Moreover, although not illustrated in FIG. 3, the individual could be provided with the ability to enter several geographical locations and indications as to when the individual will be in the various locations. For example, the user could enter a plurality of geographical locations, along with the dates that he or she will be present at those locations. This may be useful, for example, with individuals who travel often. If the individual supplies new or updated information, his or her profile would be updated appropriately.

In the individual information area 204, the questionnaire solicits basic information on the individual, including race, age, gender, religion, and the gender that the individual is seeking for a match. In the embodiment illustrated in FIG. 3, individual information area 204 also includes questions that are indicative of the individual's personality, one of which deals with the individual's behavior in a relationship situation. Although only two questions are illustrated in individual information area 204 of FIG. 3, any number of questions may be included, as was described above.

If a question in individual information area 204 relates to a particular interest or activity of the individual, the individual may also be given the opportunity to specify how important that activity is to them, for example, by rating its importance on a scale from 1 to 5. For example, if the individual specifies that he or she is interested in rock music, he or she may indicate a level of interest by choosing a number on a scale from 1 to 5. Additional uses for this sort of importance rating will be described below with respect to the match information area 206.

In the match information area 206, questions are asked about the preferences and desired attributes for prospective matches. Any attribute that can be ascribed to an individual may be the subject of a question, ranging from basics like race, age or age range, religion, political views, interests, body size, and body characteristics to traits in personality. With respect to the latter, for example, an individual might be seeking an extrovert, or a person who values intuition. As shown in FIG. 3, in match information area 206, the individual is also given the opportunity to describe how important a particular characteristic is in a potential match by specifying a trait-importance on a scale of 1 to 5.

The questionnaire 200 is subdivided as it is for ease of illustration and description; the various types of questions provided -for by the questionnaire 200 may be asked in any order and arranged in any fashion on the page, although it may be advantageous to order or arrange the questions so as not to bias the individual toward any one set of answers. Some or all of the questions and the manner of arranging and delivering them may be dictated by the particular matching algorithm that is used.

In the questionnaire 200 of FIG. 3, the individual is instructed to “answer as many questions as you like,” with the understanding that “the more questions you answer, the better we can match you.” As is indicated by the questionnaire 200, the individual or entity in method 10 does not need to answer all of the questions on the questionnaire 200, or, if he or she does choose to answer all of the questions, they need not be answered in a single sitting. The matching of task 18 in method 10 may use whatever partial information the individual has provided. If, for example, an individual answers only 60% of the questions, it may only be possible to match the individual 60% as well as would have been possible had they answered all of the questions. Individuals may answer the remainder of the questions on a questionnaire during subsequent visits. If an individual answers a number of questions that is insufficient to establish any sort of profile, the matching/coordinating system 102 may store the existing answers without attempting to match that particular profile. If particular questions are required in order to establish or store a profile, script functions, such as JavaScript functions, may be built into the code of questionnaire 200 to warn the individual of the subset of questions that must be answered to store the questionnaire properly (e.g., e-mail address and password). Script functions may also be used to warn the individual if the number and/or type of questions answered is insufficient to form a profile. In some embodiments, as will be described in greater detail below, the individual may be actively encouraged to answer more questions in subsequent sessions.

Of the tasks enumerated of method 10, tasks 18 and 20 are typically transparent to the individual and require no specific interaction from the individual. As was described above with respect to task 22 of method 10, after filling out the questionnaire, the individual would receive periodic communications detailing the times and locations at which he or she should go to a particular venue to meet prospective matches. There are several ways in which this could be done. For example, in one embodiment, the individual would be sent a message, for example, a piece of electronic mail (“e-mail”) that indicates the complete details of the event—the name and address of the venue, the predetermined time of the event, and optionally, directions to and more information on the venue. The e-mail may also include indications of the available entertainment and marketing information or advertising.

As the terms “e-mail” and “e-mail message” are used in this description, they should be construed to include both text and other types of media and multimedia content sent to a user through a personal system 108. For example, an e-mail message could include text, audio, video, or animated content sent to any sort of personal system 108.

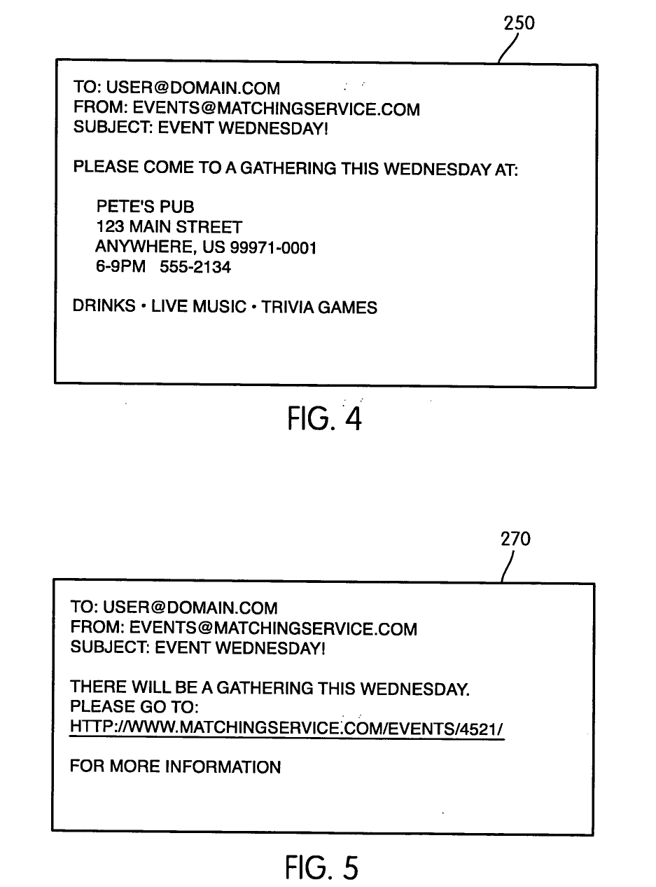

FIG. 4 is an illustration of an exemplary e-mail message 250 of this type, which lists the date and time of the event (Wednesday, 6-9PM), the venue and location (Pete's Pub), and an indication of the available entertainment. Although not illustrated in FIG. 4, e-mail message 250 might also include a link to a driving directions/mapping website or other useful links.

The advantage of the above method of distributing information to the matched individuals is that it imposes no additional burden on the individuals. The communications are received, the individuals are given full details, and they can then decide to go or not to go.

However, it may be advantageous to provide the user with only some of the information on the venue and the time of the event. Providing only some of the information avoids boring an uninterested user with a lengthy e-mail. Additionally, if an individual is provided with only some of the necessary information and a link or uniform resource locator (URL) at which the rest of the information can be accessed, the number of individuals actively interested in the event can be assessed by making a record of the individuals who access the link or URL that is provided. FIG. 5 is an illustration of an exemplary e-mail message 270 of this type, which gives only basic information (i.e., “Event this Wednesday”), and provides a URL for access to the complete information. When the individual attempts to access the URL, he or she may have to provide his or her e-mail address and password as a method of identification.

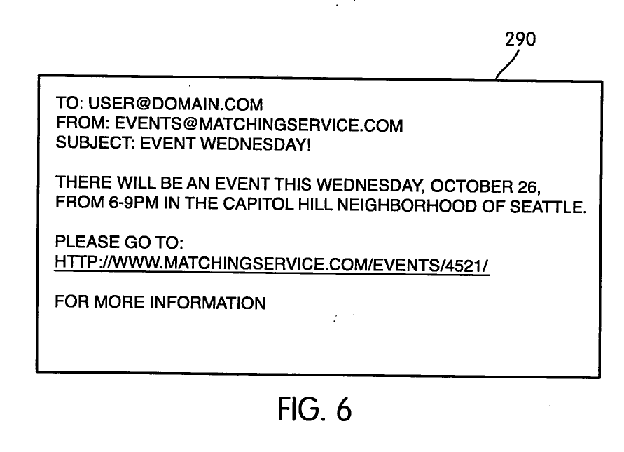

The communications that are sent may seek to balance the advantages of e-mail message 250 and e-mail message 270. For example, FIG. 6 is an illustration of an e-mail message 290 that includes the date and time of the event, the general neighborhood (Capitol Hill), the city (Seattle), and a URL for access to the complete information. E-mail message 290 thus provides enough information to give an individual a general idea of whether or not he or she would be interested in an event, but not enough to stand on its own. Therefore, the individual must go to the URL provided for complete information on where the event is to be held.

If an e-mail message such as e-mail messages 270 and 290 requires that an individual go to a particular URL to access information about an event, when the individual does so, he or she may be presented with additional optional questions, advertising, or any other type of content along with the information on the event. In one embodiment, if an individual has answered only 40 of 50 questions on a questionnaire, he or she may be presented with a single optional question to answer. For example, a bar at the top or on the side of the screen might provide a single question for the user to answer. In this way, over the course of several log-ins, an individual might be encouraged to finish answering the questions in a questionnaire, even if he or she did not initially complete the entire questionnaire. This may help to obtain information on reticent individuals or other entities who might be overburdened by the idea of answering fifty questions, but who can spare the time to answer a single question.

Even if an individual has already completed the entire questionnaire, upon accessing a URL in e-mail message 270 or 290 for more information about an event, he or she may still be presented with one or more optional questions in order to update the information available on the individual. For example, if a new musical group has come to prominence since the individual originally answered the questionnaire, he or she may be asked whether he or she likes the new musical group. However, any questions or other content presented to the user after accessing a URL to obtain more information about an event are most advantageously presented in a way that can be bypassed by the individual, so as not to increase the burden on the individual.

Although the description above presents the Internet and World Wide Web/browser paradigm as one example of an interactive interface that may be used in method 10, other types of interactive interfaces are also suitable for use with method 10 and other methods according to embodiments of the invention. For example, the functions described above could be carried out using a client application (other than a browser) that is installed on the personal systems 108, such as an application program on a desktop or laptop computer. The interactive interface could also be implemented as hardware or software and embedded in a device acting as a personal system 108, such as a cellular phone or personal digital assistant.

As was described above, method 10 focuses on matching entities. However, once a sufficient number of questionnaires have been filled out by various entities and stored under the auspices of the matching/coordinating system 102, the inplementer of method 10 has, in effect, a database of the personalities, styles and other match-relevant information of a plurality of entities. Within reason, that database can be used to commercial advantage.

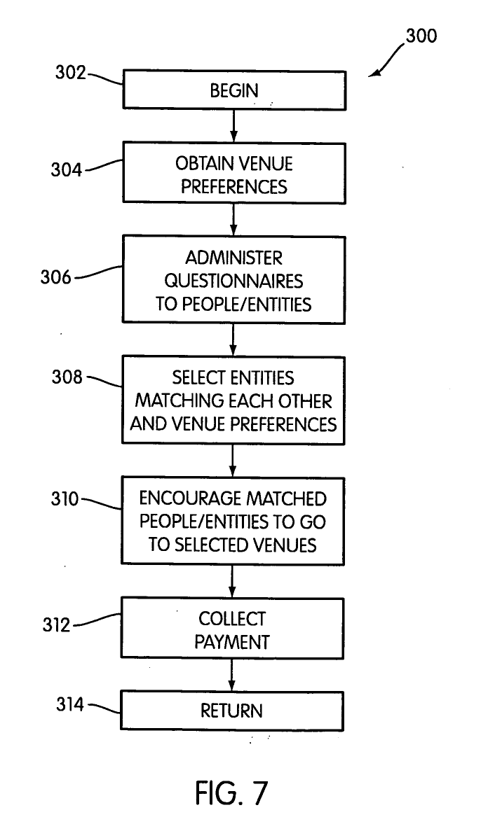

FIG. 7 is a schematic flow diagram of a method, generally indicated at 300, for facilitating interaction with selective marketing. In contrast to method 10, method 300 focuses on the preferences of a venue or an event in matching and selecting individuals to attend that event. Specifically, in method 300, entities are selected to attend an event because they match preferences specified by the venue or event. In one embodiment, for example, two individuals might be. mutual matches who also match the preferences of the venue or event. In other embodiments, two individuals may be deemed mutual matches simply because they both match the preferences set forth by the venue or event.

Method 300 begins at 302 and continues with task 304, in which venue or event preferences related to a venue or event are specified. If the preferences are related to a venue, the venue would usually be seeking to increase its patronage. For example, the venue of task 304 might be seeking to increase its patronage during specific business hours in which patronage is typically low. If the preferences are related to an event, the event planner or proprietor would usually be seeking individuals with certain characteristics to attend the event.

During task 304, any venue or event preferences may be specified. For example, a venue might specify the number of patrons it is seeking, the times and dates during which it would like the patrons to be present, the minimum and maximum number of patrons that the venue will accommodate, and the number of times or events for which patrons are sought. A venue may also specify the type of patrons it is seeking—their ages, genders, interests, geographical locations, and any or all other characteristics specified in a profile or through a questionnaire. An event planner for an event might be seeking much the same. For example, if the event in question is a particular cultural festival, the event planner might be looking to increase the attendance of patrons who share an interest in the particular culture.

Once the venue or event preferences are gathered in task 304, method 300 continues much like method 10. Specifically, in task 306, questionnaires are administered to entities and stored. In task 308, matching entities are selected. However, in method 300, the matching entities that are selected also match the venue or event preferences established in task 304. Once matching entities are selected in task 308, the selected matching entities are caused or encouraged to go to the venue or event in task 310. Task 310 may be performed in much the same way as task 22 of method 10, by sending communications to the matched entities using the information gathered by the questionnaires.

After task 310, method 300 continues with task 312. In task 312, the operator of method 300 negotiates and collects payment from the venue or event. In most applications of method 300, the venue or event will be asked to compensate the operator of method 300 because the operator of method 300 is essentially performing a highly targeted marketing service for the venue or the event. The operator of method 300 may choose to be compensated according to any available metric. For example, the venue operator or event promoter might pay based on how many venue preferences were expressed (i.e., with venues or events specifying only age paying less than venues or events specifying age, race, and gender). Additionally, the venue operator or event promoter might pay based on the total number of communications that are sent to entities to cause or encourage them to attend the event.

However, in one embodiment that is advantageous for both the operator of method 300 and the venue operator or event promoter, e-mail messages with links, such as e-mail messages 270 and 290, would be sent and the venue operator or event promoter would pay based on the number of individuals who accessed the resource to get more information about the venue or event. This particular embodiment of method 300 is advantageous because the venue operator or event planner would, in effect, be paying for only those communications that generated some interest or marketing result.

Other metrics may be used, such as the patron count during the event as compared with the average typical patron count. The particular pricing metric and the actual cost of the marketing transaction may be negotiated between the venue operator or event promoter and the operator of method 300 to fit the particular circumstances.

Although illustrated as occurring after task 310, task 312, the negotiation and collection of payment, may occur at any appropriate point in method 300. Once payment collection is complete, method 300 terminates at task 314.

While the invention has been described with respect to certain exemplary embodiments, the description is intended to be illustrative, rather than limiting. Modifications and changes may be made within the scope of the invention, which is determined by the appended claims.

What is claimed is:

1. A method of facilitating interaction, comprising:
gathering substantially anonymous match-relevant information from a first entity to form a first profile;
matching the first profile with another profile belonging to a second entity; and
causing or encouraging the first and second entities whose profiles match to go to a particular venue or event at a predetermined time.

2. The method of claim 1, wherein the first and second entities are people.

3. The method of claim 1, further comprising gathering substantially anonymous match-relevant information from the second entity to form the other profile.

4. The method of claim 2, wherein during the matching, the other profile is selected as matching from a plurality of available profiles.

5. The method of claim 1, further comprising matching the first profile and the other profile to a profile of the venue or event.

6. The method of claim 5, wherein the method further comprises gathering the profile of the venue or event.

7. The method of claim 2, wherein the substantially anonymous match-relevant information comprises an electronic contact address, a geographical location, and personality-specific information.

8. The method of claim 3, wherein gathering the substantially anonymous match-relevant information to form the first profile and the other profile comprises questioning the first and second entities using an interactive interface.

9. The method of claim 8, wherein the interactive interface is provided via an electronic network.

10. The method of claim 1, wherein matching the first profile with the other profile comprises matching the first and the other profile to within a match threshold.

11. The method of claim 1, wherein, once present at the venue or event, the first entity and the second entity are not required to identify themselves as having been participants in the method.

12. The method of claim 1, wherein the venue is geographically convenient to the first entity and the second entity.

13. Machine-readable instructions interoperable with a machine to perform the tasks of the method of claim 1.

14. The method of claim 1, further comprising collecting a fee in exchange for the causing or encouraging.

15. A method of selective marketing, comprising:
obtaining venue or event preferences related to a venue or event;
gathering substantially anonymous match-relevant information from a first entity to form a first profile;
matching the first profile with another profile belonging to a second entity; and
causing or encouraging first and second entities whose profiles match each other and the venue or event preferences to go to the venue or event.

16. The method of claim 15, further comprising collecting a fee in exchange for the causing or encouraging.

17. The method of claim 15, wherein the matched first and second entities are caused or encouraged to go to the venue or event at a predetermined time.

18. The method of claim 15, wherein the causing or encouraging comprises contacting at least one of the matched first and second entities electronically with full information on the venue or event; or
contacting at least one of the matched first and second entities electronically with partial information on the venue or event, requiring the at least one of the first and second entities to access a resource for more information, and recording access information related to the resource.

19. Machine-readable instructions interoperable with a machine to perform the tasks of the method of claim 15.

20. A matching service that:
administers questionnaires indicative of geographical location and personality to a plurality of individuals using an interactive interface;
matches ones of the plurality of individuals based on the questionnaires; and
causes or encourages matched ones of the plurality of individuals to go to a particular venue or event at a predetermined time.

21. The matching service of claim 20, wherein the questionnaires are administered via a network.

22. The matching service of claim 20, wherein the matched ones of the plurality of individuals are caused or encouraged via electronic mail.

23. The matching service of claim 20, wherein the questionnaires do not solicit individual names, addresses, or telephone numbers.

24. The matching service of claim 20, wherein the matching service collects a fee from the particular venue or event.
